(19) United States
(12) Patent Application Publication
(10) Pub. No.: US 2026/0023995 A1
(43) Pub. Date: Jan. 22, 2026

(54) Systems and Methods for Providing QUBITS via a Quantum Communication Channel

(71) Applicant: Wells Fargo Bank, N.A., San Francisco, CA (US)

(72) Inventors: Abhijit Bhima RAO, Irvine, CA (US); Jeff J. STAPLETON, O'Fallon, MO (US); Peter BORDOW, Fountain Hills, AZ (US)

(21) Appl. No.: 18/666,300

(22) Filed: May 16, 2024

(51) Int. Cl. G06N 10/40; G06N 10/20

(52) U.S. Cl. CPC G06N 10/40; G06N 10/20

(57) ABSTRACT

Systems and methods are disclosed herein for providing qubits via a quantum communication channel. An example method includes receiving a set of quantum generator nodes, a request for the qubits and a profile for generating the qubits. The example method also includes determining a quantum generator node for delivering the qubits to the endpoint device based on properties of the quantum generator node and the profile and selecting a quantum circuit and a device configuration based on the properties of the quantum generator node and the profile. The example method also includes causing execution of the quantum circuit to generate the qubits. Finally, the example method further includes causing transfer of the qubits to the endpoint device.

### BACKGROUND

Generating and distributing entangled photons or other particles (qubits) in particular quantum states is important for several applications, most notably in key generation and other security-related processes. High-quality randomness from quantum measurements is also important for certain types of simulation and testing. For certain applications, the ability to repeat conditions is invaluable for performing testing under controlled conditions.

### BRIEF SUMMARY

Network security devices of the future will rely not only on modern cryptography and digital signatures, but additionally the distribution of qubits to ensure network security and protection of data. However, not all providers of entangled qubits (or other qubits, in certain applications) assure the same quality in terms of noise, degree of entanglement, or other relevant factors. Researchers, developers, and manufacturers may have differing requirements on the characteristics and/or the quantum state of qubits needed for different applications. Qubits may also be distributed to provide a source of high-quality entropy, for example, for cybersecurity, cryptography, or other high-performance computations.

Example embodiments disclosed herein include an entanglement-as-a-service (EaaS) architecture that uses a structure for mixing and providing quality assurance of streams of qubits (e.g., entangled particles or particles otherwise prepared in a specified quantum state) provided by a combination of various on-premises and off-premises quantum particle sources (e.g., quantum particle generator nodes, quantum computers, or the like). Qubits may be retrieved from providers such as outside vendors and streams may be systematically allocated to provide qubits for endpoint devices and/or applications with specified requirements. Quality assurance may be provided by diverting a small sample of the qubits for testing to determine quality and store a profile for future generation of qubits. In an exemplary embodiment, a profile is a quantum computing (QC) circuit. This QC circuit, when executed, generates the entangled qubits. Qubits are logical manifestations of quantum particles. Another example aspect of this profile may use quantum tomography to characterize and quantify desired state of entangled qubits. The profile may also include various sources of errors and imperfections in the quantum computer, and such a profile is referred to as noise profile. The profile as explained in this disclosure is a combination of several aspects such as those explained above and other metadata to build reliable and scalable quantum entangled qubits (e.g. quantum particles). The quantum particle sources may have varying selectable characteristics which may not necessarily be known or tested ahead of time. Example systems may additionally provide a service via an API, gRPC, and/or other mechanism to handle calls from end nodes with varying entropy requirements.

Traditionally, quantum key distribution (QKD), using protocols such as BB84 or E91, for example, is performed between two parties, where one party typically generates and measures qubits and the other measures the generated qubits or particles. Variations of these schemes are possible, however, where a trusted source may generate particles and distribute them to clients, either to establish secure communications between multiple clients or in other configurations. However, variations exist between different quantum generator nodes that may result in varying qualities of service across networks, making it difficult to ensure trustworthiness or reproducibility of results.

In contrast, example methods disclosed herein introduce a portable profile for generating secure data that may be recorded during the generation of qubits, transmitted to other quantum generator nodes, and/or used subsequently to generate qubits according to the recorded profile. Additionally or alternatively, profiles may be created by directly defining desired characteristics of the quantum particle generation. Example embodiments thus improve the scalability of quantum-based technologies across large, distributed networks with several quantum generator nodes (e.g., quantum computers or other devices capable of producing and transmitting qubits).

Accordingly, the present disclosure sets forth systems, methods, and apparatuses that provide qubits (e.g., secure data encoded as the quantum state of a set of particles) via a quantum communication channel. There are many advantages of example embodiments disclosed herein. For example, users conducting testing or research using streams of qubits may use the portable profile capabilities to utilize multiple quantum generator devices, improving uptime of applications requiring quantum generators. Additionally, quantum generator node devices such as quantum computers may be utilized more fully by recording and creating profiles with associated timestamps. Users are more easily able to replay past performance by retrieving profiles and generating qubits to study previous behavior.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for providing qubits via a quantum communication channel in accordance with some example embodiments described herein.

FIG. 2 illustrates a schematic block diagram of example circuitry embodying a quantum secure communication system that may perform various operations in accordance with some example embodiments described herein.

FIG. 3 illustrates an example flowchart for providing qubits via a quantum communication channel, in accordance with some example embodiments described herein.

FIG. 4 illustrates another example flowchart for providing qubits via a quantum communication channel, in accordance with some example embodiments described herein.

FIG. 5 illustrates another example flowchart for providing qubits via a quantum communication channel, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “qubit” as used herein may refer generally to information conveyed in the quantum state of a system. In example embodiments disclosed herein, secure information may be transmitted from a device in the form of a qubit, typically by transferring one or more particles that have been prepared according to a particular quantum state. The use of the term “qubit” herein should not be construed as limiting example embodiments to the domain of quantum computing, nor the use of the term “qubit” be construed as limiting the transfer of information by example embodiments to digital information or information encoded in two-state systems.

### System Architecture

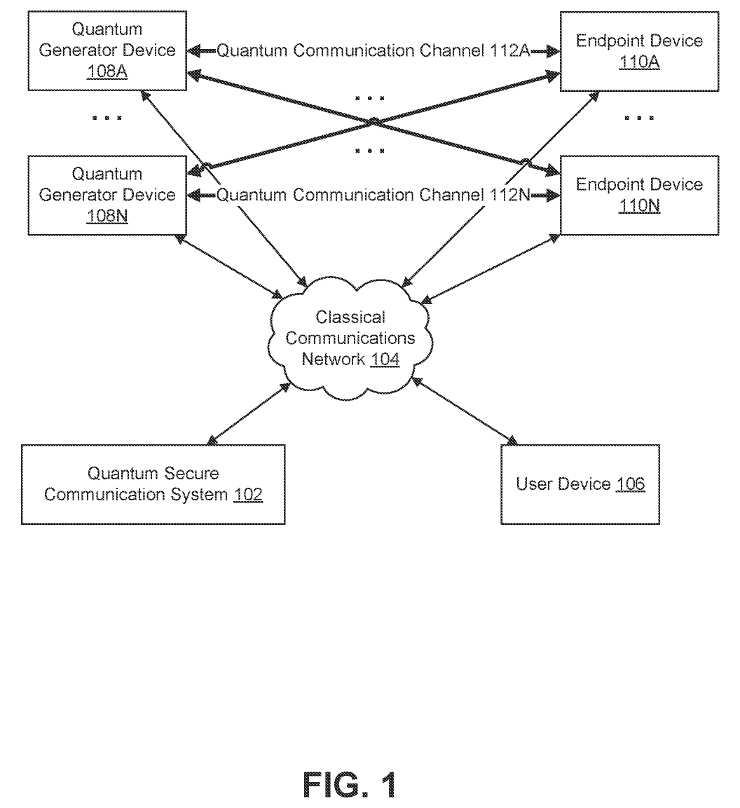

Example embodiments described herein may be implemented using any of a variety of computing devices or servers. To this end, FIG. 1 illustrates an example environment within which various embodiments may operate. As illustrated, a quantum secure communication system 102 may receive and/ or transmit information via communications network 104 (e.g., the Internet) with any number of other devices, such as user device 106.

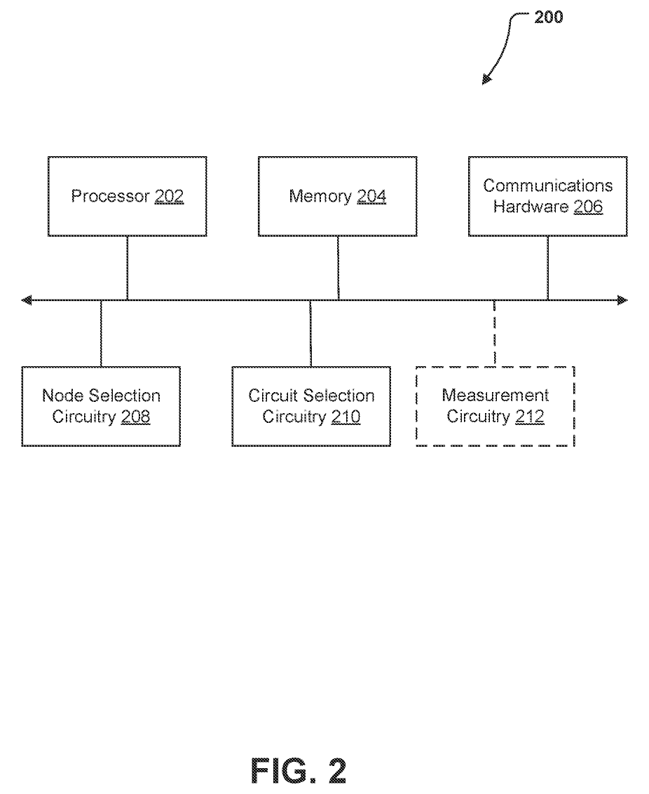

The quantum secure communication system 102 may be implemented as one or more computing devices or servers, which may be composed of a series of components. Particular components of the quantum secure communication system 102 are described in greater detail below with reference to apparatus 200 in connection with FIG. 2. The bidirectional communication between 102 and 104 may be based on a combination of several mechanisms, e.g., using quantum teleportation to transfer quantum states between nodes and using measurement results to reconstruct the teleported state. Quantum tomography techniques may be used to prepare and measure quantum states sent through quantum communication system.

The user device 106 may be embodied by any computing devices known in the art. The user device 106 need not be an independent device but may be embodied as one or more peripheral devices communicatively coupled to other computing devices.

The one or more of quantum generator device 108A through quantum generator device 108N may be embodied as a quantum computing device, quantum computer, quantum device, or any other such device capable of generating a set of particles with quantum states based on a set of gate operations defined in a quantum circuit. A quantum generator device 108A-108N may be a specialized computing device which stores and operates on information in quantum states. A quantum computer may make use of the quantum mechanical principles of superposition and entanglement to perform operations that are impossible on classical computers operating on classical information. Quantum computers may include devices relying on technologies such as superconducting circuits, trapped ions, atoms in optical lattices, or any other of a wide array of technologies used to prepare and manipulate quantum states. Quantum computers may be gate-based, or perform operations dictated by a quantum circuit, or series of operators or logic gates that represent different transformations on the stored quantum states. A device embodying one of the quantum generator device 108A through quantum generator device 108N may also be realized as a simulated system on a classical computer, though without the intrinsic speedup that a physical quantum computer provides through the use of superposition and entanglement.

The one or more of endpoint device 110A through endpoint device 110N may be embodied by any computing device known in the art, including a personal computer, server, virtualized system, or the like. A device embodying an endpoint device 110A through endpoint device 110N need only be capable of receiving, or interfacing with a device or other peripheral that may receive a quantum communication via one of quantum communication channel 112A through quantum communication channel 112N.

The one or more quantum communication channel 112A through quantum communication channel 112N may be embodied by a quantum line or quantum communications path. For example, a quantum line may comprise a polarization-maintaining (PM) optical fiber (PMF or PM fiber), photonic transmission lines, photonic crystals, photonic circuitry, free space (e.g., air, vacuum), or a combination thereof. In some embodiments, a PM fiber uses birefringence to maintain the polarization states of photons. This is normally done by causing consistent asymmetries in the PM fiber. Example PM fiber types include panda fiber, which is used in telecom; elliptical clad fiber; and bowtie fiber. Any of these three designs uses birefringence by adding asymmetries to the fiber through shapes and stresses introduced in the fiber. This causes two polarization states to have different phase velocities in the fiber. As such, an exchange of the overall energy of the two modes (polarization states) becomes practically impossible. The term optical line broadly encompasses on-chip quantum lines. The one or more quantum communication channel 112A through quantum communication channel 112N may be a communications channel (e.g., an optical line, a quantum line) over which quantum data and particles, such as qubits, are exchanged using one or more quantum cryptographic techniques (e.g., QKD) that directly rely on quantum properties, such as quantum uncertainty, quantum entanglement, or both. In some embodiments, the one or more quantum communication channel 112A through quantum communication channel 112N may further include quantum-based networking infrastructure, such as quantum analogues of switches, repeaters, and or other devices that may facilitate the establishment of quantum communication channels. It will be understood that although the one or more quantum communication channel 112A through quantum communication channel 112N are depicted as connecting pairs of devices, a quantum communications channel coupled with various quantum network infrastructure may form a network rather than point-to-point communication between pairs of devices.

The one or more quantum generator device 108A through quantum generator device 108N and/or the one or more endpoint device 110A through endpoint device 110N may be configured with or in communication with circuitry that is configured to receive and/or transmit qubits from or to any other device or circuitry in communication with the quantum secure communication system 102. In this regard, these devices may include, for example, a quantum communications interface (including, but not limited to, one or more optoelectronic components) for enabling quantum communications over a quantum line. In some embodiments, such devices may be configured to receive (e.g., directly or indirectly, such as via switching circuitry) and transmit qubits, such as sets of entangled qubits. In some embodiments, the one or more quantum generator device 108A through quantum generator device 108N and/or the one or more endpoint device 110A through endpoint device 110N may be communicatively coupled to one or more quantum storage devices configured to store various quantum information, such as one or more qubits (e.g., pairs of entangled quantum particles, one entangled quantum particle in a pair of entangled quantum particles), quantum cryptographic keys, quantum one-time pads, any other suitable quantum information, any links or pointers thereto, and combinations thereof.

### Example Implementing Apparatuses

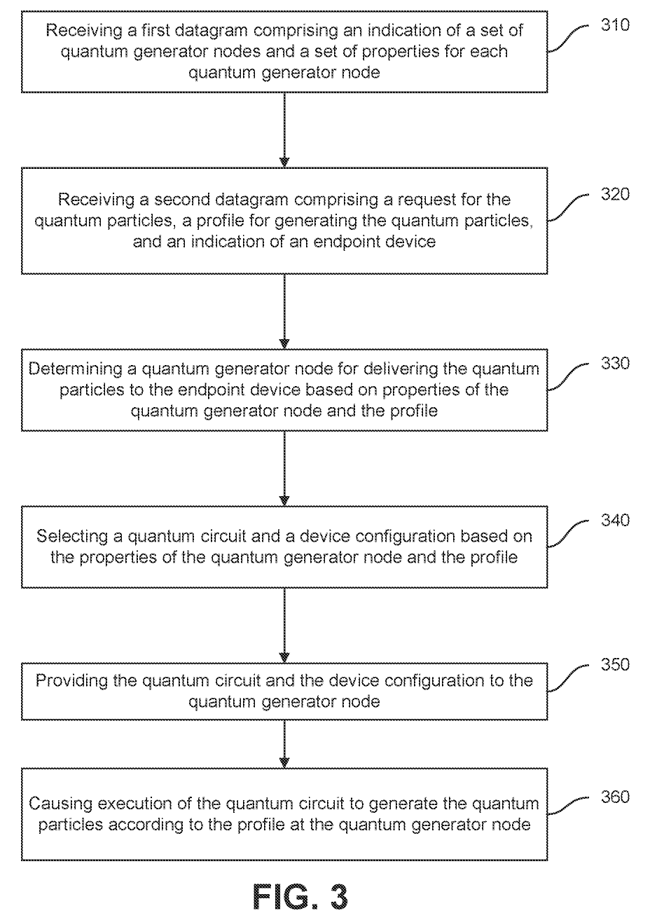

The quantum secure communication system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-5. As illustrated in FIG. 2, the apparatus 200 may include processor 202, memory 204, communications hardware 206, node selection circuitry 208, circuit selection circuitry 210, and measurement circuitry 212 each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a node selection circuitry 208 that selects a quantum generator node based on the set of available nodes and details of a request for qubits. The node selection circuitry 208 may utilize processor 202, memory 204, or any other hardware component included in the apparatus 200 to perform these operations, as described in connection with FIGS. 3-5 below. The node selection circuitry 208 may further utilize communications hardware 206 to gather data from a variety of sources (e.g., user device 106, shown in FIG. 1), and/or exchange data with a user, and in some embodiments may utilize processor 202 and/or memory 204 to select quantum generator nodes.

In addition, the apparatus 200 further comprises a circuit selection circuitry 210 that selects a quantum circuit for fulfilling a request for qubits. The circuit selection circuitry 210 may, in some embodiments, maintain a database of known quantum circuits for performing various tasks, or may algorithmically build quantum circuits based on various requests for qubits. The circuit selection circuitry 210 may utilize processor 202, memory 204, or any other hardware component included in the apparatus 200 to perform these operations, as described in connection with FIGS. 3-5 below. The circuit selection circuitry 210 may further utilize communications hardware 206 to gather data from a variety of sources (e.g., user device 106, as shown in FIG. 1), and/or exchange data with a user, and in some embodiments may utilize processor 202 and/or memory 204 to select quantum circuits.

In addition, the apparatus 200 may further comprise a measurement circuitry 212 that creates performance profiles and profiles (e.g., noise profiles) based on recorded observations of quantum generator node performance. The measurement circuitry 212 may utilize processor 202, memory 204, or any other hardware component included in the apparatus 200 to perform these operations, as described in connection with FIGS. 3-5 below. The measurement circuitry 212 may further utilize communications hardware 206 to gather data from a variety of sources (e.g., user device 106, as shown in FIG. 1), and/or exchange data with a user, and in some embodiments may utilize processor 202 and/or memory 204 to perform measurements and create profiles.

Although components 202-212 are described in part using functional language, it will be understood that the particular implementations necessarily include the use of particular hardware. It should also be understood that certain of these components 202-210 may include similar or common hardware. For example, the node selection circuitry 208 and circuit selection circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the node selection circuitry 208 and circuit selection circuitry 210 may leverage processor 202, memory 204, or communications hardware 206 as described above, it will be understood that any of node selection circuitry 208 and circuit selection circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that node selection circuitry 208 and circuit selection circuitry 210 comprise particular machinery designed for performing the functions described herein in connection with such elements of apparatus 200.

In some embodiments, various components of the apparatuses 200 may be hosted remotely (e.g., by one or more cloud servers) and thus need not physically reside on the apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of graphical user interfaces and flowcharts.

### Example Operations

Turning to FIGS. 3, 4, and 5, example flowcharts are illustrated that contain example operations implemented by example embodiments described herein. The operations illustrated in FIGS. 3-5 may, for example, be performed by the quantum secure communication system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, node selection circuitry 208, circuit selection circuitry 210, measurement circuitry 212, and/or any combination thereof. It will be understood that user interaction with the quantum secure communication system 102 may occur directly via communications hardware 206 or may instead be facilitated by a separate user device 106, as shown in FIG. 1, and which may have similar or equivalent physical componentry facilitating such user interaction.

Turning first to FIG. 3, example operations are shown for providing qubits via a quantum communication channel. As shown by operation 310, the apparatus 200 includes means, such as memory 204, communications hardware 206, or the like, for receiving a first datagram comprising an indication of a set of quantum generator nodes and a set of properties for each quantum generator node. The communications hardware 206 may receive the first datagram and unpack, decrypt, or otherwise interpret the first datagram to prepare data indicating identities of the quantum generator nodes from the set of quantum generator nodes with corresponding properties of each quantum generator node. The quantum generator nodes may be embodied, for example, as quantum generator devices 108A-108N, as depicted in FIG. 1 and described previously. The set of properties for each quantum generator node may include basic characteristics, including mutable and immutable properties of the quantum generator nodes such as number of qubits, type of quantum computing hardware (e.g., trapped ion, photonics, superconducting transmon, and/or the like), connectivity properties (e.g., properties of the associated quantum communication channel 112A through quantum communication channel 112N), various types of error rates, circuit operations per second, qubit topology, firmware and/or software versions, and/or the like.

In some embodiments, the set of quantum generator nodes and properties of the quantum generator nodes may be stored, for example, on memory 204, and retrieved. In some embodiments, the communications hardware 206 may receive an update to the stored list of quantum generator nodes and/or properties, which may be combined with the stored data to produce an updated dataset.

As shown by operation 320, the apparatus 200 includes means, such as memory 204, communications hardware 206, or the like, for receiving, by the communications hardware, a second datagram comprising a request for the qubits, a profile for generating the qubits, and an indication of an endpoint device. The communications hardware 206 may receive the first datagram and unpack, decrypt, or otherwise interpret the first datagram to prepare data indicating the request for the qubits, the profile, and the indication of the endpoint device.

The request for qubits may, for example, be a request or other transmission that triggers the creation of a key via QKD. For example, the request for qubits may be automatically generated by another process during authentication when connecting to another device. The qubits may encode secure data, for example, using entangled particles and/or particles generated according to a pre-defined set of basis vectors. The qubits may be in a quantum state useful for performing QKD using, for example, a BB84 or E91 protocol. In some embodiments, the qubits may be prepared in a quantum state used for other applications such as Monte Carlo calculations or simulations. In some embodiments, the qubits may be used for random number generation for a variety of applications, such as generation of secure keys.

The profile for generating the qubits may indicate various conditions under which the qubits are generated, including intrinsic properties of a quantum generator node and configurable properties of the generation of qubits. For example, a profile may be based on a measured performance of a particular device at a particular period of time, where the profile describes general properties of the quantum states generated. For example, the profile may include a variance of one or more measurable properties of the set of quantum states produced by the device. The profile may include properties of noise, error rates, and/or the like related to the production of the set of quantum states encoding the secure data. In some embodiments, the profile is a noise profile, and the noise profile comprises an indication of a statistical measure of quantum noise of the one or more quantum states to be generated.

As shown by operation 330, the apparatus 200 includes means, such as node selection circuitry 208, or the like, for determining a quantum generator node for delivering the qubits to the endpoint device based on properties of the quantum generator node and the profile. The node selection circuitry 208 may determine one or more matches of the properties of the quantum generator node to the profile to determine a set of candidate quantum generator nodes that may fulfil the request for qubits. The set of candidate quantum generator nodes may be filtered or reduced in any of a number of ways, such as maximizing a particular criterion, presenting the nodes to a user for selection, selecting based on load balancing or demand on the nodes, or other methods, for example. In some embodiments, the quantum generator node may be selected based on the cost or quality of delivering the qubits, including the network quality, physical proximity, and/or the like.

In some instances, there may be no quantum generator nodes that are able to fulfil the profile or other details of the request for qubits. In some embodiments, the request may be specified as an unblocking request, and the node selection circuitry 208 may select a quantum generator node even if the quantum generator node is not capable of fulfilling the request for qubits. For example, the node selection circuitry 208 may select quantum generator device 108A which comes closest to satisfying the criteria of the request for qubits. The node selection circuitry 208 may further note that the request was unable to be fulfilled exactly, but due to the unblocking property of the request, the qubits will still be generated. In some embodiments, the request for qubits may be specified as a blocking request, and the node selection circuitry 208 may return an error message or otherwise indicate that the request was not able to be fulfilled due to no available quantum generator node that meets the request criteria.

As shown by operation 340, the apparatus 200 includes means, such as memory 204, circuit selection circuitry 210, or the like, for selecting a quantum circuit and a device configuration based on the properties of the quantum generator node and the profile. The circuit selection circuitry 210 may access a database of known quantum circuits, for example, stored in memory 204, which may be applicable to different applications. The stored quantum circuits may be pre-defined quantum circuits and/or may include various adjustable parameters, such as the number of qubits or other parameters based on the type of problem to be solved. In some embodiments, the request for qubits may indicate a particular quantum circuit or class of quantum circuits, which may be passed through the circuit selection circuitry 210 to identify the same quantum circuit during operation 340.

The circuit selection circuitry 210 may further select a device configuration. The device configuration may include various options and settings that are supplied to the selected quantum generator node (e.g., one of quantum generator device 108A through quantum generator device 108N) for preparing the qubits according to the desired profile. For example, a user may select a “noisy” profile for generating entangled particles. The node selection circuitry 208 may select a newer quantum generator node capable of generating entangled particles with less noise than specified in the profile, so the circuit selection circuitry 210 may modify the device settings and configuration of the selected quantum generator node (e.g., various device-specific and/or hardware-specific configurations) to increase the noise to meet the desired profile.

As shown by operation 350, the apparatus 200 includes means, such as communications hardware 206, or the like, for providing the quantum circuit and the device configuration to the quantum generator node (e.g., one of quantum generator device 108A through quantum generator device 108N). The communications hardware 206 may prepare a datagram including an indication of the quantum circuit, a set of operations defining the quantum circuit itself, and/or other data that may cause the quantum generator node to execute the selected quantum circuit. The datagram may further include the device configuration formatted to be interpreted by the quantum generator node and used to select various configuration options of the quantum generator node. In some embodiments, the apparatus 200 may provide, via communications hardware 206, a set of high-level instructions to an intermediate node or device, which may directly interface with the quantum generator node to execute and/or implement the quantum circuit and/or device configuration.

As shown by operation 360, the apparatus 200 includes means, such as memory 204, communications hardware 206, or the like, for causing execution of the quantum circuit to generate the qubits according to the profile at the quantum generator node, wherein the qubits may encode secure data as one or more quantum states of a set of particles. As mentioned previously, the request for qubits may specify various details about the qubits, including details concerning encoding the data as a quantum state of a set of particles. The communications hardware 206 may transmit instructions or commands to cause the quantum generator node, such as one of quantum generator device 108A through quantum generator device 108N, to generate the qubits. In some embodiments, transmitting the quantum circuit, device configuration, and/or other information in a datagram may further include instructions or other data that cause the execution of the quantum circuit. It will be understood that the communications hardware 206 may transmit data causing multiple repeated executions of the quantum circuit for generating additional qubits in quantities specified by the request for qubits.

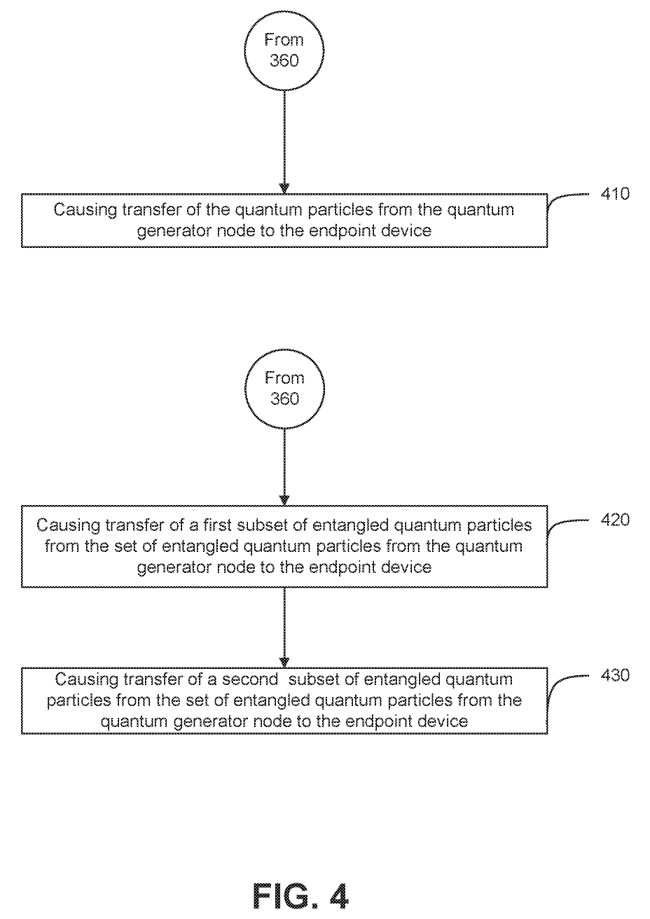

Turning now to FIG.4, as shown by operation 410, the apparatus 200 includes means, such as memory 204, communications hardware 206, or the like, for causing transfer of the qubits from the quantum generator node to the endpoint device. The qubits, generated as described previously in connection with operation 360, may be transmitted from the quantum generator node (e.g., one of quantum generator device 108A through quantum generator device 108N), to an endpoint device (e.g., one of endpoint device 110A through endpoint device 110N) via one or more quantum communication channels (e.g., quantum communication channel 112A through quantum communication channel 112N). Although depicted in FIG. 1 as directly connecting a generator node to an endpoint, the quantum communication channels may be connected via switches or other routing mechanisms to direct network traffic to the correct endpoint device. Accordingly, communications hardware 206 may transmit instructions to a quantum generator node, an endpoint device, and/or various network infrastructure devices (e.g., components of one or more of quantum communication channel 112A through quantum communication channel 112N) to cause the transfer of the qubits from the quantum generator node to the endpoint device.

The identify of the endpoint device may be given in or in connection with the request for qubits. For example, the request for qubits may be received from the endpoint device, or the request for qubits may include an identity, such as a host name or network address, of the endpoint device.

In some embodiments, the communications hardware 206 may transmit data causing the qubits to be transferred from the quantum generator node immediately or within a short time after the qubits are generated, so that the generation and transfer of the qubits may occur simultaneously or nearly simultaneously, rather than as separate steps.

Additionally, the apparatus 200 includes means, such as communications hardware 206, or the like, for providing, by an authenticated classical communication channel, control data to the endpoint device. In some embodiments, the communications hardware 206 may provide additional data that may be supplemental to the qubits. In some embodiment, the control data comprises an indication of a basis state for generating the one or more quantum states of the set of particles. For example, communications hardware 206 may transmit or cause another device to transmit control data necessary for determining a shared secret using a BB84 QKD protocol. The control data may include an indication of a quantum basis state used for performing a measurement of a quantum state of one or more particles used for encoding the quantum state of the set of qubits. The control data may be determined locally by apparatus 200 or another device, such as one of quantum generator device 108A through quantum generator device 108N, and communications hardware 206 may cause transmission of the control data to the appropriate endpoint device (e.g., one of endpoint device 110A through endpoint device 110N).

In some embodiments, the qubits may encode secure data as a set of entangled qubits. As described previously, the qubits may be part of an E91 protocol for QKD. In such embodiments, the quantum generator node may prepare a set of entangled particles. The set of entangled particles may be divided so that two or more subsets of entangled particles are formed, and each particle in the subset of entangled particles is entangled with a particle from a different subset of entangled particles.

As shown by operation 420, the apparatus 200 includes means, such as communications hardware 206, or the like, for causing transfer of a first subset of entangled qubits from the set of entangled qubits from the quantum generator node to the endpoint device. In some embodiments, the secure data and/or the set of qubits that convey the secure data may be transferred to two or more endpoint devices. For example, the second datagram may further comprise an indication of a second endpoint device. In some embodiments, the set of entangled qubits may be divided into subsets as described previously, and each subset may be transferred to a separate endpoint device, so that a first endpoint device has a particle that is entangled with a particle available to a second endpoint device.

As shown by operation 430, the apparatus 200 includes means, such as communications hardware 206, or the like, for causing transfer of a second subset of entangled qubits from the set of entangled qubits from the quantum generator node to the second endpoint device. As described above in connection with operation 420, the communications hardware 206 may cause transfer of the second subset of entangled qubits to the second endpoint device.

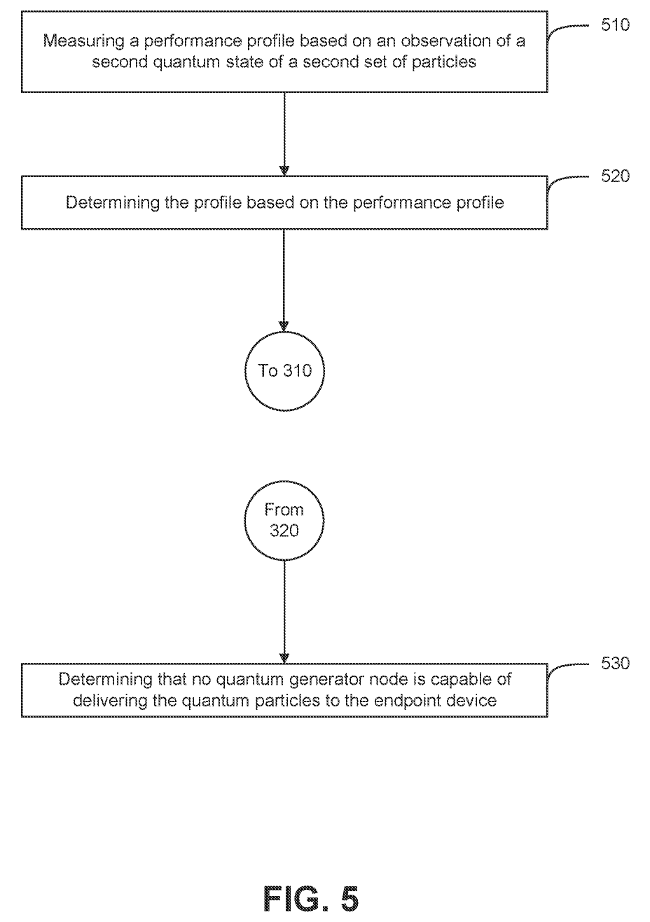

Turning now to FIG. 5, as shown by operation 510, the apparatus 200 may include means, such as measurement circuitry 212, or the like, for, generating a performance profile based on an observation of a second quantum state of a second set of particles. In some embodiments, the apparatus 200 may be configured to make an observation of a second quantum state of a second set of particles. For example, a quantum generator node may produce a set of particles, and information regarding the noise profile of the quantum state may be collected in the form of various statistical measures of noise. The measurement circuitry 212 may cause the observations to be taken or may collect the observations from various connected devices of the network, the endpoint device, and/or quantum generator node. In some embodiments, the observations may be based on a sample of a subset of the set of particles, to avoid changing the quantum state by observation. The measurement circuitry 212 may subsequently collect the observations, process the data, and produce a performance profile. The performance profile may comprise, for example, various statistical measures that describe distributions of observable quantities of the quantum states of the set of particles.

As shown by operation 520, the apparatus 200 may include means, such as memory 204, measurement circuitry 212, or the like, for determining the profile based on the performance profile. The measurement circuitry 212 may further prepare a profile based on the performance profile by cleaning, annotating, or otherwise preparing the data of the performance profile. In some embodiments, the profile prepared in this way may be stored in memory 204 or the like to be recalled by a future request for qubits. The profile may also include and/or be associated with a timestamp for later recall. For example, a user may provide a request for qubits using a “replay” request to receive data that was generated at a particular time in the past. The apparatus 200 may retrieve the profile generated by measurement circuitry 212 that is matched to the relevant timestamp stored in memory 204. The retrieved profile may then be used to generate the qubits as described in FIGS. 3-5.

As shown by operation 530, the apparatus 200 may include means, such as memory 204, node selection circuitry 208, or the like, for determining that no quantum generator device is capable of delivering the qubits to the endpoint device. The selection circuitry 208 may compare the request for qubits with the available quantum generator devices and associated properties (including network connectivity to various endpoint devices). In some instances, the selection circuitry 208 may determine that it is not possible to fulfil the request for qubits based on the available quantum generator nodes and their current properties.

In an instance in which the selection circuitry 208 determines that the request for qubits cannot be fulfilled, the node selection circuitry 208 may transmit a message indicating that the request could not be fulfilled, accompanied by an error code or other explanation. The message may be transferred to the original device submitting the request and/or the endpoint device expecting to receive the qubits. In some embodiments, the node selection circuitry 208 may select the closest available device to fulfil a modified request based on the original request for qubits. For example, the original request for qubits may have an unblocking property, indicating to the node selection circuitry 208 that qubits should be provided to the endpoint device even if every element of the original request is not able to be met. For example, a lower quality or a lower number of qubits belonging to the quantum generator device may be substituted to fulfill an unblocking request.

### Conclusion

As described above, example embodiments provide methods and apparatuses that enable improved transmission of qubits via quantum communication channels. By taking into account various quality and profile parameters for generation of qubits, example embodiments improve reproducibility and extend the utility of quantum computers and other similar devices.

As these examples all illustrate, example embodiments contemplated herein provide technical solutions that solve real-world problems faced in the field of network security. While quantum key distribution and related subjects have been active fields for some time now, techniques to extend their usefulness and scale their capabilities to larger networks and organizations are still needed. Example embodiments disclosed herein employ a novel architecture for managing distribution of qubits via quantum communication channels, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing qubits via a quantum communication channel, the method comprising:
receiving, by communications hardware, a first datagram comprising an indication of a set of quantum generator nodes and a set of properties for each quantum generator node;
receiving, by the communications hardware, a second datagram comprising a request for the qubits, a profile for generating the qubits, and an indication of an endpoint device;
determining, by node selection circuitry, a quantum generator node for delivering the qubits to the endpoint device based on properties of the quantum generator node and the profile;
selecting, by circuit selection circuitry, a quantum circuit and a device configuration based on the properties of the quantum generator node and the profile;
providing, by the communications hardware, the quantum circuit and the device configuration to the quantum generator node;
causing execution of the quantum circuit to generate the qubits according to the profile at the quantum generator node; and
causing transfer of the qubits from the quantum generator node to the endpoint device.

2. The method of claim 1, further comprising:
providing, by the communications hardware and an authenticated classical communication channel, control data to the endpoint device.

3. The method of claim 2, wherein the control data comprises an indication of a basis state for generating the one or more quantum states of the set of particles.

4. The method of claim 1, wherein the qubits are a set of entangled quantum particles.

5. The method of claim 4, wherein the second datagram further comprises an indication of a second endpoint device, the method further comprising:
causing transfer of a first subset of entangled quantum particles from the set of entangled quantum particles from the quantum generator node to the endpoint device; and
causing transfer of a second subset of entangled quantum particles from the set of entangled quantum particles from the quantum generator node to the second endpoint device.

6. The method of claim 1, further comprising:
generate, by measurement circuitry, a performance profile based on an observation of a second quantum state of a second set of particles; and
determining, by the measurement circuitry, the profile based on the performance profile.

7. The method of claim 1, wherein the profile is a noise profile, wherein the noise profile comprises an indication of a statistical measure of quantum noise of the one or more quantum states.

8. An apparatus for providing qubits via a quantum communication channel, the apparatus comprising:
communications hardware configured to:
receive a first datagram comprising an indication of a set of quantum generator nodes and a set of properties for each quantum generator node, and
receive a second datagram comprising a request for the qubits, a profile for generating the qubits, and an indication of an endpoint device;
node selection circuitry configured to:
determine a quantum generator node for delivering the qubits to the endpoint device based on properties of the quantum generator node and the profile; and
circuit selection circuitry configured to:
select a quantum circuit and a device configuration based on the properties of the quantum generator node and the profile,
wherein the communications hardware is further configured to:
provide the quantum circuit and the device configuration to the quantum generator node,
cause execution of the quantum circuit to generate the qubits according to the profile at the quantum generator node, and
cause transfer of the qubits from the quantum generator node to the endpoint device.

9. The apparatus of claim 8, wherein the communications hardware is further configured to:
provide, by an authenticated classical communication channel, control data to the endpoint device.

10. The apparatus of claim 9, wherein the control data comprises an indication of a basis state for generating the one or more quantum states of the set of particles.

11. The apparatus of claim 8, wherein the qubits are entangled quantum particles.

12. The apparatus of claim 11, wherein the second datagram further comprises an indication of a second endpoint device, wherein the communications hardware is further configured to:
cause transfer of a first subset of entangled quantum particles from the set of entangled quantum particles from the quantum generator node to the endpoint device; and
cause transfer of a second subset of entangled quantum particles from the set of entangled quantum particles from the quantum generator node to the second endpoint device.

13. The apparatus of claim 8, further comprising measurement circuitry configured to:
generate a performance profile based on an observation of a second quantum state of a second set of particles; and
determine the profile based on the performance profile.

14. The apparatus of claim 8, wherein the profile is a noise profile, wherein the noise profile comprises an indication of a statistical measure of quantum noise of the one or more quantum states.

15. A computer program product for providing qubits via a quantum communication channel, the computer program product comprising at least one non-transitory computer-readable storage medium storing program instructions that, when executed, cause a system to:
receive a first datagram comprising an indication of a set of quantum generator nodes and a set of properties for each quantum generator node;
receive a second datagram comprising a request for the qubits, a profile for generating the qubits, and an indication of an endpoint device;
determine a quantum generator node for delivering the qubits to the endpoint device based on properties of the quantum generator node and the profile;
select a quantum circuit and a device configuration based on the properties of the quantum generator node and the profile;
provide the quantum circuit and the device configuration to the quantum generator node;
cause execution of the quantum circuit to generate the qubits according to the profile at the quantum generator node; and
cause transfer of the qubits from the quantum generator node to the endpoint device.

16. The computer program product of claim 15, further comprising additional program instructions that, when executed, cause the system to:
provide, by an authenticated classical communication channel, control data to the endpoint device.

17. The computer program product of claim 16, wherein the control data comprises an indication of a basis state for generating the one or more quantum states of the set of particles.

18. The computer program product of claim 15, wherein the qubits are a set of entangled quantum particles.

19. The computer program product of claim 18, wherein the second datagram further comprises an indication of a second endpoint device, wherein the computer program product further comprises additional program instructions that, when executed, cause the system to:
causing transfer of a first subset of entangled qubits from the set of entangled qubits from the quantum generator node to the endpoint device; and
causing transfer of a second subset of entangled qubits from the set of entangled qubits from the quantum generator node to the second endpoint device.

20. The computer program product of claim 15, further comprising additional program instructions that, when executed, cause the system to:
generate a performance profile based on an observation of a second quantum state of a second set of particles; and
determine the profile based on the performance profile.
